(19) United States
(12) Patent Application Publication
(10) Pub. No.: US 2007/0298722 A1
(43) Pub. Date: Dec. 27, 2007

(54) Method and system for detecting change in attributes of RF board in base station

(75) Inventor: Bong Gi Choi, Anyang-si (KR)

Correspondence Address: KED & ASSOCIATES, LLP, P.O. Box 221200, Chantilly, VA, 20153-1200, US

(73) Assignee: LG-Nortel Co., Ltd.

(21) Appl. No.: 11/812,720

(22) Filed: Jun. 21, 2007

(30) Foreign Application Priority Data
Jun. 22, 2006 (KR) 10-2006-0056235

(51) Int. Cl. H04B 17/00; H04B 1/38

(52) U.S. Cl. 455/67.11; 455/561

(57) ABSTRACT

A method of controlling operation of a base station involves calibrating an RF board in the base station, by measuring transmission power of the board and then determining a transmission power attenuation based on the measured power and a target transmission power. A variation of the transmission power attenuation is calculated based on previous transmission power attenuation and the determined attenuation, and the calculated variation is the compared with a predetermined threshold value. An alarm message is provided based on the result of the comparison.

### BACKGROUND

1. Field

One or more embodiments described herein relate to systems and method for performing wireless mobile communications.

2. Background

To provide a wireless mobile communication service, multiple base stations are typically located over a wide area. In operation, each base station manages a cell in which service is provided. Further, each base station should have transmission power sufficient to provide service within the cell. However, if transmission power is too large, it may cause interference in cells of neighboring base stations. Therefore, the transmission power of each base station needs to be controlled to minimize interference, while still allowing sufficient power to be generated to provide service within its own cell. Such controlled transmission power is typically referred to as “target transmission power.”

However, related-art methods of controlling transmission power in a base station have proven unreliable or ineffective, especially in cases where power deviates as a result of hardware limitations or low response times. A need therefore exists for an improved method for controlling transmission power in a base station.

### BRIEF DESCRIPTION OF THE DRAWINGS

The embodiments will be described in detail with reference to the following drawings in which like reference numerals refer to like elements, wherein:

FIG. 1 is a diagram of one embodiment of a system for detecting a change in attributes of an RF board;

FIG. 2 is a diagram of one type of calibration controller that may be used in the system of FIG. 1; and

FIG. 3 is a flow chart showing steps included in one embodiment of a process for providing a Tx Atten reference alarm message in a system such as shown in FIG. 1.

### DETAILED DESCRIPTION

In order to ensure adequate performance, the transmission power of a base station in a mobile communication system should be controlled. When initializing a base station, an operator performs calibration so that transmission power can be set to target transmission power. However, if the base station operates for a long period of time, attributes of a radio frequency (RF) board in the base station may change. This, in turn, may cause transmission power to gradually change.

That is, because hardware devices generally tend to deteriorate after long periods of use, it stands to follow that elements in the RF board will likely deteriorate over time. This deterioration may cause various attributes of the RF board to change, which may cause the transmission power of the base station to deviate from the value(s) set by initial calibration.

To compensate for changes in transmission power brought about by changes in attributes of the RF board, the base station may periodically perform a calibration operation which involves resetting transmission power to a target transmission power. By performing this operation, any changes in transmission power of the base station due to changes in attributes of the RF board can be compensated, preferably on a continuous basis. The period and time of the calibration may be specified by an operator.

When periodic calibration is performed, changes in transmission power of the base station can be compensated but only to a certain extent when related-art methods are employed. Further, the adjustable range of the transmission power attenuation (Tx Atten), which generally has great effects upon the transmission power of the base station, has upper and lower limit values. If the attributes of the RF board change rapidly or continuously, the transmission power of the base station may not be adjusted to the target transmission power merely by performing periodic calibration (e.g., Tx Atten of the RF board may deviate from the limit values). If such situation occurs, then the approach in the related art is to replace the RF board with another board, in order to allow transmission power to be set to the target transmission power. RF board replacement requires service to be stopped, thereby making it difficult to provide seamless and real-time service.

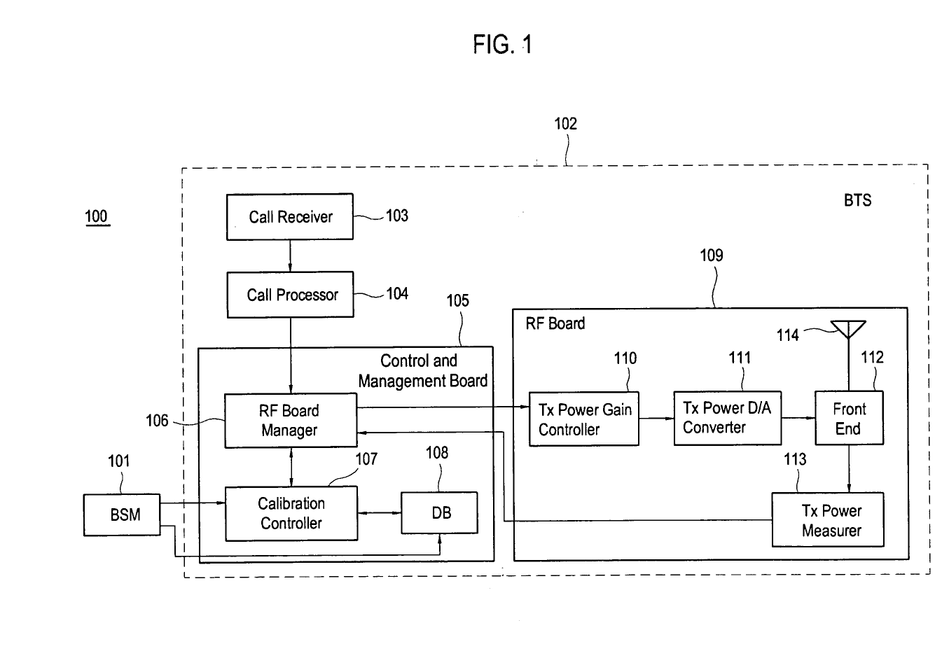

FIG. 1 shows one embodiment of a system 100 for detecting a change in attributes of an RF board which, for example, may be installed in a base station or other portion of a mobile communication system. The system includes a base station management (BSM) unit 101 and a base transceiver station (BTS) 102.

The BSM provides an interface for an operator to manage the BTS. Through the BSM, the operator may set a default value of a target transmission power (Tx power) of BTS 102, give instructions for calibration to the BTS, and receive results from calibration of the BTS.

The BTS may include a call receiver 103, a call processor 104, a control and management board 105 and a radio frequency (RF) board 109. The call receiver receives a call to be transmitted through the BTS. The call may include voice traffic and/or data traffic. The call processor modularizes and transmits the received call with total digital power. In an exemplary embodiment, the call processor may include a modem.

The control and management board 105 may include an RF board manager 106, a calibration controller 107, and a database (DB) 108. The RF board manager 106 provides an interface between the call processor 104, the calibration controller 107, and the RF board 109. The RF board manager also receives a modulated call from the call processor 104 and transmits the call to the RF board 109. The RF board manager also receives control information on Tx power gain from the calibration controller and transmits the information to the RF board. Further, the RF board manager receives the measured value of the Tx power from the RF board and transmits the value to the calibration controller 107.

The calibration controller 107 controls calibration of the Tx power of the RF board 109. The calibration may be performed when the calibration controller receives a start instruction from the operator through BSM 101. Alternatively, the calibration may be performed periodically at a predetermined time according to the operator's instructions through the BSM. The calibration controller may also read the default value of target Tx power stored in the DB 108, which is inputted by the operator through BSM 101.

Based on the value of target Tx power and the measured value of the Tx power, which is received from RF board manager 106, the calibration controller may produce control information on Tx power gain. The calibration controller may then transmit the produced control information on Tx power gain to the RF board manager and store the information in DB.

In accordance with one embodiment, the control information on Tx power gain may be indicative of Tx power attenuation (Tx Atten). For example, Tx Atten may be represented as a dB value. In such case, the larger the value of Tx Atten, the smaller the Tx power becomes. In other embodiments, the cited information on Tx power gain may be indicative of another transmission parameter.

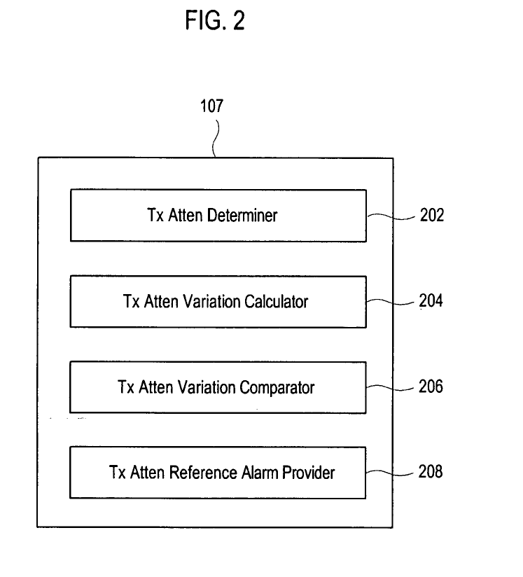

Calibration controller 107 may transmit the calibration result to BSM 101 after calibration is completed. The calibration controller may also detect a change in one or more attributes of the RF board and then transmit an alarm message to the BSM. These features are explained in greater detail below, for example, with reference to FIG. 2.

In accordance with one embodiment, the calibration controller periodically executes calibration as set by a timer (not shown). The operator may determine beforehand the period and time of performing calibration, and the calibration controller may execute calibration at the time set by the operator. According to another embodiment, the calibration controller may execute calibration based on an instruction from the operator. For example, the operator may transmit a calibration start instruction to the calibration controller through BSM 101. In response to the instruction, the calibration controller may execute the calibration operation. In another embodiment, the calibration controller may execute calibration according to an instruction from the operator while periodically executing calibration.

In accordance with any of the aforementioned embodiments, the calibration operation may include overhead (OVHD) calibration and/or overhead/total power tracking loop (OVHD/TPTL) calibration. OVHD calibration refers to calibration performed on basic channels (OVHD channel; e.g., pilot, sync, paging channels, etc.) used by the modem of the base station for providing terminal services. OVHD/TPTL calibration refers to calibration performed on a traffic channel (including voice and data traffic) with the OVHD channel. OVHD calibration may be performed while BTS is not receiving any calls (i.e., traffic channel is not used), and OVHD/TPTL calibration may be performed while BTS is receiving certain calls (i.e., traffic channel is used).

The database (DB) 108 may store default value of target Tx power, control information on Tx power gain, and the result of calibration as well as other information. The operator may store the default value of target Tx power in the DB through BSM 101. The calibration controller may read the default value of target Tx power from the DB and execute calibration based on the value. Further, the calibration controller may store control information on Tx power gain and the result of calibration in the DB.

The RF board 109 may include a Tx power gain controller 110, a Tx power D/A converter 111, a front end 112, a Tx power measurer 113 and an antenna 114. The Tx power gain controller receives control information on Tx power gain with a modulated call from the RF board manager 106 in the control and management board 105. The Tx power gain controller 110 controls the Tx power gain for the modulated call based on the received control information on the Tx power gain. The Tx power D/A converter 111 receives the call from the Tx power gain controller. The Tx power D/A converter then converts digital RF power of the call to analog RF power to transmit the call with a predetermined RF power. The front end 112 transmits the call, the power of which is transformed to analog power in the Tx power D/A converter 111, through the antenna. The Tx power measurer 113 measures the Tx power transmitted from the front end and transmits the measured value of the Tx power to RF board manager 106 in the control and management board.

FIG. 2 shows one embodiment of calibration controller 107 which includes a Tx Atten determiner 202, a Tx Atten variation calculator 204, a Tx Atten variation comparator 206 and a Tx Atten reference alarm provider 208.

The Tx Atten determiner 202 determines transmission power attenuation (Tx Atten) based on the measured value of the Tx power, which is received from the RF board manager 106 as well as the value of target Tx power read from the DB 108 to execute calibration on the RF board 109.

The Tx Atten variation calculator 204 calculates the variation of the Tx Atten based on the previous Tx Atten and the currently determined Tx Atten. The Tx Atten variation comparator 206 compares the variation, which is calculated in the Tx Atten variation calculator 204, with a threshold value that is previously set by the operator.

The Tx Atten reference alarm provider 208 provides a Tx Atten reference alarm message if the result of the comparison performed by the Tx Atten variation comparator 206 indicates that the variation is larger than the threshold value.

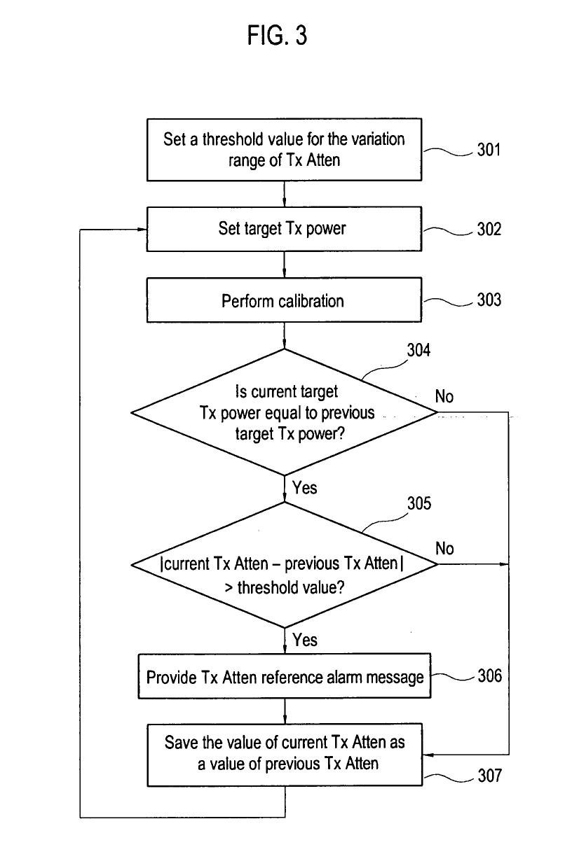

FIG. 3 shows steps included in one embodiment of a process of providing alarm message using, for example, the system and controller respectively shown in FIGS. 1 and 2. At step 301, the operator sets a threshold value for the variation range of a predetermined operating parameter of the transmitter, such as Tx Atten. The operator may determine the threshold value, for example, to be an appropriate value based on his/her own experience or based on an external analysis or the requirement of a specific application or desired performance of the system.

When the system has been operating for a long time, the RF board may deteriorate. Thus, in accordance with the present embodiments, the value of Tx Atten may be changed to a different value in a predetermined period of time, which is shorter than the said long time which may be determined beforehand. The degree of change in the value of the Tx Atten due to the deterioration of the RF board may vary depending on the system conditions. Therefore, based on his/her experience of operating the system, and/or the other criteria previously mentioned, the operator or alternatively a central program may determine that deterioration of the RF board has become serious when variation of the Tx Atten value at a certain device reaches a certain level. Based on such experiences, the operator may determine an appropriate threshold value in advance and may store that value in DB 108 through BSM 101. In other embodiments, the operator or a control program may determine that deterioration of RF board performance fallen below an acceptable level based on a parameter different from Tx Atten value.

At step 302, the operator sets the target Tx power. The target Tx power, for example, may be set to a value that can provide a predetermined quality of service in the cell of BTS 102, while minimizing the effects (e.g., interference) on the cells of neighboring BTSs.

At step 303, the operator or control program may perform a calibration operation on the Tx power of BTS 102. As previously described, the calibration may be periodically performed as set by a timer, and may be performed according to an instant instruction from the operator.

Steps 304 to 307 illustrate the process of detecting a change in attributes of the RF board, to provide a reference alarm message (e.g., a Tx Atten reference alarm message) in the calibration controller 107. At step 304, it is determined whether the current target Tx power is equal to the previous target Tx power. If the two values of the target Tx power are not substantially the same, then it is determined that the change in the Tx Atten value is not caused by a change in attributes of the RF board. Accordingly, the Tx Atten reference alarm message is not generated.

At step 307, the value of the previous Tx Atten is updated to the value of the current Tx Atten. If the two values of the target Tx power are at least substantially the same, then the value of the current Tx Atten is compared with the value of the previous Tx Atten at step 305. If the difference between the values of the current Tx Atten and the previous Tx Atten is greater than a threshold value, which is set by the operator at step 301, then the Tx Atten reference alarm message is provided to BSM 101 at step 306.

On the other hand, if the difference between the values of the current Tx Atten and the previous Tx Atten is less than the threshold value, then it is determined that any change in attributes of the RF board is not significant. The process then proceeds to step 307 without providing the Tx Atten reference alarm message.

At step 307, the value of the previous Tx Atten is updated to the value of the current Tx Atten. The process then goes back to step 302 and the above steps may be repeated.

Thus, in accordance with the aforementioned embodiment, the change in Tx Atten values for calibration can be continuously monitored in order to timely detect the change in attributes of the RF board. Accordingly, the operator can replace or repair the RF board at an appropriate time, by timely detecting the change in attributes of the RF board without stopping the service being provided.

According to one embodiment, a method may be provided to detect a change in attributes of a radio frequency (RF) board in a base station. Such a method may include: calibrating said RF board in said base station, wherein said calibrating includes measuring transmission power (Tx power) of said RF board, and determining transmission power attenuation (Tx Atten) based on said measured Tx power and target Tx power; calculating variation of Tx Atten based on previous Tx Atten and said determined Tx Atten; comparing said calculated variation with a predetermined threshold value; and providing a Tx Atten reference alarm message based on the result of said comparison.

According to another embodiment, a system may be provided to detect a change in attributes of a radio frequency (RF) board in a base station. Such a system may include: a transmission power attenuation (Tx Atten) determiner for determining Tx Atten based on transmission power (Tx power) of said RF board in said base station and target Tx power, wherein said determining Tx Atten constitutes a part of process of calibrating said RF board in said base station; a Tx Atten variation calculator for calculating variation of Tx Atten based on previous Tx Atten and current Tx Atten; a Tx Atten variation comparator for comparing said variation of Tx Atten with a predetermined threshold value; and a Tx Atten reference alarm provider for providing a Tx Atten reference alarm message based on the result of said comparison.

Any reference in this specification to “one embodiment,” “an embodiment,” “example embodiment,” etc., means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling operation of a base station, comprising:
calibrating an RF board in said base station, said calibrating including measuring transmission power (Tx power) of said RF board and determining a transmission power attenuation (Tx Atten) based on said measured Tx power and a target Tx power;
calculating a variation of the Tx Atten based on a previous Tx Atten and said determined Tx Atten;
comparing said calculated variation with a predetermined threshold value; and
providing a Tx Atten reference alarm message based on the result of said comparison.

2. The method of claim 1, wherein the Tx Atten reference alarm message indicates that transmission power of the base station has changed as a result of a change in one or more attributes of the RF base.

3. The method of claim 1, wherein providing a Tx Atten reference alarm message includes providing the Tx Atten reference alarm message when said calculated variation is greater than said threshold value.

4. The method of claim 1, further comprising setting said target Tx power of said RF board, wherein comparing said calculated variation with said threshold value is performed when the value of said set target Tx power is at least substantially equal to a previous value of target Tx power.

5. The method of claim 1, further comprising determining said threshold value based on said one or more attributes of said RF board.

6. The method of claim 1, wherein said calibrating is repeated periodically.

7. The method of claim 1, wherein said calibrating is performed in response to an instruction entered by an operator.

8. The method of claim 1, wherein the target Tx power is set to a level which causes interference of signals transmitted from the base station into a cell of another base station to be below a desired level.

9. A system for controlling operation of base station, comprising:
a transmission power attenuation (Tx Atten) determiner to determine a Tx Atten based on a transmission power (Tx power) of an RF board in said base station and a target Tx power, wherein said determiner determines a the Tx Atten value as a part of a process of calibrating said RF board in said base station;
a Tx Atten variation calculator to calculate a variation of the Tx Atten value based on a previous Tx Atten and the determined Tx Atten value;
a comparator to compare said variation of the Tx Atten value with a predetermined threshold value; and
a reference alarm provider to provide a Tx Atten reference alarm message based on said comparison.

10. The system of claim 1, wherein the Tx Atten reference alarm message indicates that transmission power of the base station has changed as a result of a charge in one or more attributes of the RF board.

11. The system of claim 9, wherein said reference alarm provider provides the Tx Atten reference alarm message when said variation is greater than said threshold value.

12. The system of claim 9, wherein said calibrating is repeated periodically.

13. The system of claim 9, the comparator compares said variation with the predetermined threshold value when the target Tx power is at least substantially equal to a previous value of the target Tx power.

14. The system of claim 9, wherein said calibration process is performed in response to an instruction entered by an operator.

15. The system of claim 9, wherein the target Tx power is set to a level which causes interference of signals transmitted from the base station into a cell of another base station to be below a predetermined level.

16. A method for controlling operation of a base station, comprising:
measuring transmission power of an RF board of the base station;
determining an operating parameter of the base station based on the measured transmission power;
comparing a variation of the operating parameter to a predetermined value; and
determining that the transmission power of the base station has changed as a result of a change in one or more attributes of the RF board.

17. The method of claim 16, further comprising:
generating an alarm message after determining said change in the transmission power of the base station.

18. The method of claim 16, further comprising:
adjusting the transmission power of the base station to at least substantially correspond with a target transmission power.

19. The method of claim 18, wherein the target transmission power is set to a level which causes interference of signals transmitted from the base station into a cell of another base station to be below a desired level.

20. The method of claim 16, wherein the operating parameter is a transmission power attenuation value.

21. The method of claim 19, further comprising:
calibrating the RF board,
wherein the transmission power is measured and the operating power is determined during said calibration of the RF board.

22. The method of claim 21, wherein the RF board is calibrated in response to an instruction from an operator.

23. The method of claim 21, wherein the RF board is calibrated on a periodic basis.

24. A system for controlling operation of a base station, comprising:
a detector to measure transmission power of an RF board of the base station;
a circuit to determine an operating parameter of the base station based on the measured transmission power; and
a processor to compare variation of the operating parameter to a predetermined value and determine that the transmission power of the base station has changed as a result of a change in one or more attributes of the RF board.

25. The system of claim 24, wherein the processor generates an alarm message after determining said change in the transmission power of the base station.

26. The system of claim 24, wherein the processor adjusts the transmission power of the base station to at least substantially correspond with a target transmission power.

27. The system of claim 26, wherein the target transmission power is set to a level which causes interference of signals transmitted from the base station into a cell of another base station to be below a desired level.

28. The system of claim 24, wherein the operating parameter is a transmission power attenuation value.

29. The system of claim 24, further comprising:
a calibration circuit to calibrate the RF board,
wherein the detector measures the transmission power during a calibration operation performed by the calibration circuit.

30. The system of claim 29, wherein the calibration circuit calibrates the RF board in response to an instruction from an operator.

31. The system of claim 29, wherein the calibration circuit calibrates the RF board on a periodic basis.
